(19) United States
(12) Patent Application Publication
(10) Pub. No.: US 2008/0012754 A1
(43) Pub. Date: Jan. 17, 2008

(54) Delay based sector beam synthesis in a multi-beam antenna system

(75) Inventor: Shiwei Gao, Nepean (CA)

Correspondence Address: Lawrence G. Kurland, Esq.;BRYAN CAVE LLP, 1290 Avenue of the Americas, New York, NY, 10104-3300, US

(73) Assignee: TenXc Wireless Inc.

(21) Appl. No.: 11/784,099

(22) Filed: Apr. 4, 2007

(30) Foreign Application Priority Data
Apr. 4, 2006 (CA) 2,547,647

(51) Int. Cl. H01Q 3/00

(52) U.S. Cl. 342/194; 342/368

(57) ABSTRACT

A novel method and apparatus for synthesizing beams in a multi-beam antenna system is disclosed. In such systems, adjacent beams typically have overlapping coverage areas. When a common signal is broadcast across a plurality of such overlapping beams, the introduction of phase differences between adjacent beams may destructively interfere, resulting in reduced coverage area, significant fading or possibly even loss of the signal. The present invention introduces a temporal delay in alternating beams so that even if a common signal is broadcast, the temporal delay will minimize the likelihood of significant destructive interference. The delay may correspond to a symbol period, a multiple or fraction thereof, or a chirp, depending upon the encoding scheme employed. Where no common signal is to be broadcast, the imposition of a delay on a subset of the beams has negligible effect.

### CROSS REFERENCE TO RELATED APPLICATIONS

This application claims the benefit of Canadian Patent Application Serial No. 2,547,647, filed Apr. 4, 2006, which disclosure is incorporated herein by reference in its entirety.

### FIELD OF THE INVENTION

The present invention relates to network planning and in particular to improved beam synthesis in a multi-beam antenna system.

### BACKGROUND TO THE INVENTION

In wireless communications systems, the frequency spectrum is a scarce resource that must be efficiently used. For a finite amount of spectrum, there is an upper bound on the number of subscribers that could be served simultaneously. To increase the number of subscribers, multiple access techniques have been introduced in the past.

One such multiple access technique involves multiple beam antenna systems in which different subscriber signals are transmitted (and received) along different antenna beams. The different beams are generated from a plurality of antenna array elements that are varied in phase and amplitude.

A hallmark of such multiple beam antenna systems is that the beams have narrow extent. This ensures that the beam maximizes antenna gain and limits co-channel interference. In such a system, adjacent beams are typically partially overlapped to achieve uniform coverage. Not infrequently, adjacent beams will have slightly or even significantly different phase responses to a received or transmitted signal.

However, on occasion, there is a need to broadcast a common signal along a plurality of the differing beams. For example, the transmitting base station may wish to broadcast a message periodically to all subscribers in the system such as a Broadcast Control Channel (BCCH) in GSM/EDGE (Global System for Mobile Communications/Enhanced Data for GSM Evolution) systems or a pilot channel in the Universal Mobile Telecommunications System (UTMS) and Carrier Detect Multiple Access (CDMA) systems. This calls for the synthesis of a sector beam pattern for the broadcast traffic in either or both of the uplink and downlink directions.

A similar situation is faced in compensating for gain drops between two adjacent beams in both the uplink and downlink directions. When the phase responses of the adjacent beams are nearly out of phase, the transmitted signals from the adjacent beams in the downlink will be added together destructively in the overlapping areas, causing reduced coverage range in those areas. The same applies to the uplink. This is equivalent to reduced antenna gains in those overlapping directions.

In such a circumstance, phase differences between adjacent beams prove to be disadvantageous, if not corrected.

If a subscriber were to be located in a region across which a plurality of beams overlap, the beams may be out of phase. Because the same signal content is being transmitted across all of the overlapping beams, the beams may effectively destructively interfere, precluding the signal content from being received by the receiver. Even if the signals are not completely out of phase, but only largely so, the resulting fading may pose significant problems for the receiver.

One mechanism for resolving this conundrum is to calibrate the magnitude and phase of each beam and its associated circuitry. That is, the phase delay is measured at each stage of the antenna system, from the antenna port through all of the circuit components down to the baseband level.

This is not a trivial task, as the phase delay will vary with a number of factors, including the ambient temperature. Effectively, calibration systems do calculations on-line and on an approximately continuous basis, which involves considerable complexity and expense. Even so, on-line calibration is notoriously difficult to achieve.

However, without such system calibration, the combined beam pattern in the downlink may have unpredictable notches at the overlapping directions due to possible out-of-phase combining.

### SUMMARY OF THE INVENTION

Accordingly, it is desirable to provide an antenna system with beam patterns that are tailored to compensate for fading due to phase differences when the beams are synthesized.

It is further desirable to provide an antenna system that obviates the need for online calibration of phase delays throughout the circuitry.

The present invention accomplishes these aims by introducing a time delay for one beam relative to its adjacent beams to prevent signal cancellations.

In effect, the introduced time delay compensates for the phase delay. The present invention relies upon the assumption that a signal value is much less likely to be exactly or significantly out of phase with its immediately subsequent signal value than with its contemporaneous signal value along an adjacent beam.

Having recognized that the most significant degree of overlap is between adjacent beams, one mechanism for so doing is to delay alternating beams by a delay.

According to a first broad aspect of an embodiment of the present invention there is disclosed a method for synthesizing a plurality of beams comprising at least one first beam having a coverage area overlapping with a coverage area of at least one second beam in a multi-beam antenna system comprising:
transmitting at least one first signal to be broadcast across a corresponding one of the at least one first beam;
transmitting at least one second signal after a delay across a corresponding one of the at least one second beam, so that a delay is applied to the at least one first signal relative to the at least one second beam;
whereby when the at least one first signal and the at least one second signal are identical, the likelihood of destructive interference between the at least one first beam and the at least one second beam is minimized.

According to a second broad aspect of an embodiment of the present invention there is disclosed an apparatus for synthesizing a plurality of beams in a multi-beam antenna system, comprising:
at least one first beam processor having a corresponding at least one first beam; and
at least one second beam processor having a corresponding at least one second beam, the coverage area of the at least one first beam overlapping the coverage area of the at least one second beam;
each of the at least one second beam processors comprising a delay element so that a delay may applied to at least one second signal to be broadcast along a corresponding one of the at least one second beam relative to at least one first signal to be broadcast along a corresponding one of the at least one first beam;
whereby, when the first and second signals are identical, the likelihood of destructive interference between the at least one first beam and the at least one second beam is minimized.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a multi-beam system in accordance with an exemplary embodiment of the present invention;

FIG. 2 is a block diagram of a quadrature phase modulator for use in the multi-beam system of FIG. 1;

FIG. 3 is a block diagram of a digital up-converter for use in the multi-beam system of FIG. 1;

FIG. 4 is a block diagram of an RF circuit for use in the multi-beam system of FIG. 1;

FIG. 5 is a graph of a simulated channel frequency response showing no phase delay between otherwise identical signals in adjacent beams in the multi-beam system of FIG. 1;

FIG. 6 is a graph of a simulated channel frequency response showing 180° phase delay between otherwise identical signals in adjacent beams in the multi-beam system of FIG. 1; and

FIG. 7 is a block diagram of a multi-base system in accordance with a alternative exemplary embodiment of the present invention.

### DETAILED DESCRIPTION OF THE PREFERRED EMBODIMENTS

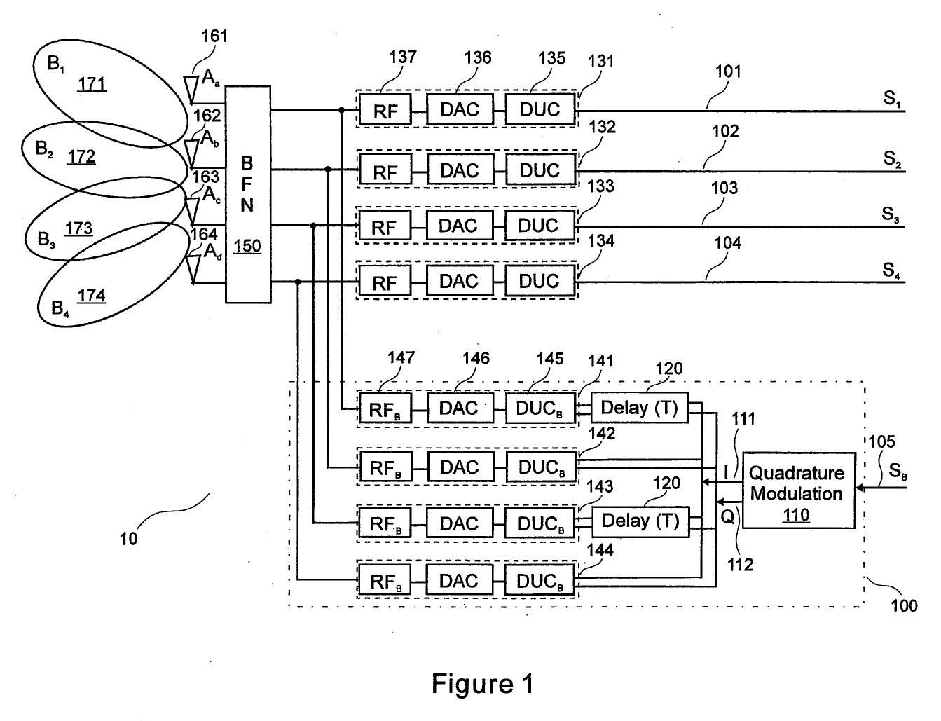

Turning now to FIG. 1, there is shown an exemplary multi-beam system, shown generally at 100, in accordance with the present invention. The system 100 is adapted to be introduced in a switched configuration into a transmit portion of a conventional multi-beam system, shown generally at 10.

Such conventional multi-beam system 10 may comprise a plurality of conventional beam processing blocks 131-134, a beamformer network 150 and a plurality of antenna elements Aₐ-A_{d} 161-164. The number of conventional beam processing blocks 131-134 corresponds to the number of beams B₁-B₄ 171-174, which in the exemplary embodiment is 4.

Each conventional beam processing block 131-134 is connected by an input signal line 101-104 to different signal services and to an input of the beamformer network 150. It acts on a digital signal s₁-s₄ that it receives along its corresponding input signal line 101-104, processes and feeds into the corresponding input of the beamformer network 150.

Each conventional beam processing block 131-134 may comprise a digital up-converter circuit 135, a digital to analog (D/A) converter 136 and an RF circuit 137 connected in series configuration.

Each digital up-converter circuit 135 accepts a digital signal sᵢ corresponding to the beam processing block 131-134 that is intended to be transmitted along a corresponding beam Bᵢ 171-174, up-converts the signal to an intermediate frequency and passes it on to the corresponding digital to analog (D/A) converter 136.

Each digital to analog (D/A) converter 136 accepts the intermediate frequency digital signal and converts it to an analog signal and passes it on to the corresponding RF circuit 137.

Each RF circuit 137 accepts the analog signal and converts it to RF and passes it on to a corresponding input of the beamformer network 150.

The beamformer network 150 is connected at each of its inputs to the output of a corresponding RF circuit 137 and at each of its outputs to a corresponding one of the plurality of antenna elements 161-164. The beamformer 150 applies a set of beamforming weights to each of the signals arriving along a particular input to generate a plurality of signals, that may be differentiated in phase and time, to each of its outputs. A different set of beamforming weights may correspond to and be applied to the signal at each input of the beamformer network 150.

The signal generated by the beamformer network 150 at each of its outputs drives the corresponding one of the plurality of antenna elements 161-164 to generate a corresponding beam B₁-B₄ 171-174.

Thus, the number of beams B₁-B₄ 171-174 corresponds to the number of conventional beam processing blocks 131-134 and to the number of digital signals s₁-s₄ 101-104, but not necessarily to the number of antenna elements Aₐ-A_{d} 161-164.

Conventionally, the content of each input signal s₁-s₄ is different.

However, as indicated above, there may be occasions when common signal content is desired to be transmitted along adjacent beams. For example, in FIG. 1, there is shown a broadcast signal s_{B} that is intended to be transmitted along each of the beams B₁-B₄ 171-174.

The inventive system 100 is connected by a broadcast input signal line 105 and generates a plurality of signals that correspond to each input of the beamformer network 150.

Preferably, the multiplicity of signals sᵢ and s_{B} that are tied to a common input of the beamformer network 150 as shown in FIG. 1, may be controlled by switching means (not shown) at the beamformer network 150, although those having ordinary skill in this art will readily appreciate that switching, whether expressly or merely by manipulation and/or design of the communication protocol, can also be accomplished at the input signal level.

The inventive system 100 comprises a quadrature phase modulator 110, a plurality of delay elements 120 and a plurality of broadcast beam processing blocks 141-144.

The quadrature phase modulator 110 accepts a digital broadcast signal s_{B} along the broadcast input signal line 105 and generates an in-phase (I) and quadrature (Q) broadcast signal component that it outputs along corresponding in-phase 111 and quadrature 112 signal lines.

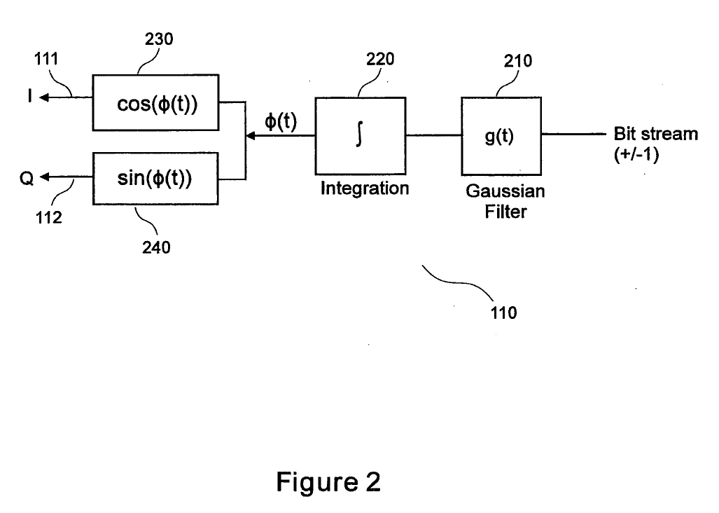

An exemplary structure of the quadrature phase modulator 110 suitable for use with Gaussian Minimum-phase Shift Keying (GMSK) coding is shown in FIG. 2. It comprises a Gaussian filter 210, an integrator 220, a cosine function 230 and a sine function 240. The digital broadcast signal s_{B} received along the broadcast input signal line 105 is sequentially fed into the Gaussian filter 210 followed by the integrator 220. The resulting digital function φ(t) is then fed into each of the cosine function 230, thus generating the in-phase broadcast signal component along in-phase signal line 111 and the sine function 240, thus generating the quadrature broadcast signal component along quadrature signal line 112, separated in phase by 90°. The quadrature phase modulator 110 operates in the digital domain.

Referring again to FIG. 1, both the in-phase and the quadrature signal lines are fed, either directly or indirectly into each of the broadcast beam processing blocks 141-144. In approximately half of the cases, the signals are fed first into each of the plurality of delay elements 120 before being fed into the corresponding broadcast beam processing blocks 141, 143 along a delayed in-phase signal line 111 and a delayed quadrature signal line 112.

The delay element 120 introduces a delay amount T. Those having ordinary skill in this art will readily recognize that the delay could be conveniently implemented in baseband with a digital signal processor (DSP), a floating point gate array (FPGA) or with a First In First Out (FIFO) buffer. The delay is in both the in-phase (I) and quadrature (Q) paths after the quadrature phase modulator 110. Those having ordinary skill in this art will appreciate that the delay could conceivably be implemented anywhere along the transmit path within the digital domain.

The delay elements are interposed between the quadrature phase modulator 110 and those broadcast beam processing blocks 141, 143 corresponding to alternate beams B₁ 171, B₃ 173, so that every second beam will be carrying signal content that is delayed in time by T and any pair of adjacent beams will not contain identical signal content (viewed from a temporal basis).

For GSM systems, a sufficient delay would be roughly equivalent to one symbol period. When the delay difference between beams is over one symbol period (approximately 3.7 μs for GSM systems), the phase difference between the beams will change from one symbol to another due to the fact that the modulation bits are random and the phase of the symbols after modulation is also random.

For CDMA, it is contemplated that a time delay corresponding to a single chirp (single modulation period within a symbol period) may be sufficient. Those having ordinary skill in this art will readily recognize that other delay periods, involving multiples or fractions of symbol periods may also be suitable.

As a general principle, however, introducing too much additional delay may cause implementation problems because the additional delay may call for an equalizer to be implemented within the receiver in order to recover the signal. Different delays can be provided for different groups of beams, but in general, less delay is desirable for the receiver.

The broadcast beam processing blocks 141-144 are similar in structure to the conventional beam processing blocks 131-134 in that they each comprise a series-connected broadcast digital up-converter circuit 145, a digital to analog (D/A) converter 146 and a broadcast RF circuit 147.

However, as discussed below, both the broadcast digital up-converter circuit 145 and the broadcast RF circuit 147 differ in design from their conventional counterparts 135 and 137 respectively and process both an in-phase (I) and quadrature (Q) component of the broadcast signal.

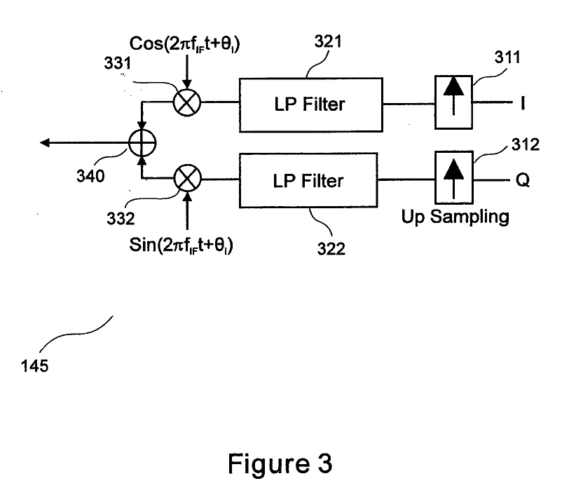

Turning now to FIG. 3, there is shown an exemplary block diagram for the broadcast digital up-converter circuit 145. It comprises a pair of up-samplers 311, 312, a pair of low pass filters 321, 322, a pair of mixers 331, 332 and a combining mixer 340. The in-phase (I) and quadrature (Q) components are for the most part handled separately and only combined at the combining mixer 340.

The in-phase component arriving along the in-phase signal line 111 from the quadrature phase modulator 110 or along the delayed in-phase signal line 121 from one of the delay elements 120 is up-sampled by the corresponding up-sampler 311, and fed into the corresponding low pass filter 321. Up-sampling is an interpolation process, in which the sampling rate of the signal is increased from typically symbol rate to a multiple of symbol rate so that the image frequency is further away from the principle spectrum frequency in order to relax the filtering requirement for the following analog circuits. The interpolation process consists of two parts: up-sampling and filtering. The in-phase component is then mixed with a cosine signal cos (2πf_{IF}t+θᵢ), where:
f_{IF} is the intermediate frequency, and
θᵢ is a random phase component.

The handling of the quadrature component is largely similar except that it is mixed with a sine signal sin (2πf_{IF}t+θᵢ).

The resulting components, having been up-converted to the intermediate frequency are then combined together by the combining mixer 340 and output to the digital to analog (D/A) converter 146, which may be identical to the conventional digital to analog (D/A) converter 136 and which converts the digital signals to analog form.

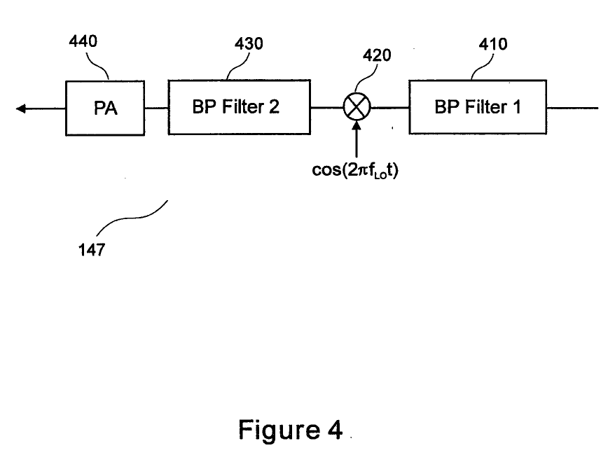

Turning now to FIG. 4, there is shown an exemplary block diagram for the broadcast RF circuit 147. It comprises first and second band pass filters 410, 430, separated by a cosine mixer 420 and followed by a power amplifier 440.

The analog signal output by the digital to analog (D/A) converter 146 is fed through the first band pass filter 410, to allow the desired signal to be transmitted while eliminating other spectrum components, and mixed by the cosine mixer 420 with the cosine function cos (2πf_{LO}t), where:
f_{LO} is Local oscillator frequency.

Thereafter, the resulting signal is fed through the second (optional) band pass filter 430 and then amplified by the power amplifier 440.

In operation, effectively, a frequency selective multipath channel is created in the downlink so that at the receiver, the equalization recovers the signals from the different beams, which have different delays, and is able to coherently combine them into an enhanced signal.

At the overlapping juncture between two adjacent beams, the composite signal may be expressed as:
x(t)=h₁s(t)+h₂e^{jθ}s(t−T) (1)
where: s(t) is the transmitted signal;
h₁ is the complex channel response of the (undelayed) first beam including all associated circuitry;
h₂ is the complex channel response of the (delayed) second beam including all associated circuitry;
θ is the random phase purposely introduced to the second beam; and
T is the signal delay purposely introduced into the second beam.

It can be seen that the resulting composite signal from the two beams is equivalent to the signal after undergoing a two-ray multipath propagation.

When the delay T is equal to or greater than one symbol duration, the equivalent multipath channel becomes frequency selective, meaning that the amplitude response of the channel is not flat across the transmitted signal bandwidth.

For mobile subscribers having an equalizer in their associated receivers, the two-path signals may be picked up and combined to enhance the signal quality without specialized equipment.

One such equalizer is the well-known Viterbi equalizer frequently used in GSM handsets and base stations. In a CDMA/UMTS system, a Rake receiver is similarly typically used in the handset to recover signals from multi-path channels.

The phase θ introduced into the second beam remains constant within a frame, but varies from frame to frame. Such variation is random and in the range of 0 to 360°. The phase variation across frames is intended to create diversity effects such that any possible worst case phase combination of h₁ and h₂ will not linger for any appreciably long time.

The frequency domain representation of Equation (1) is as follows:
x(f)=h₁s(f)+h₂s(f)e^{j2πfT}=(h₁+h₂e^{jθ}e^{j2πfT})s(f)=h(f)s(f) (2)
where: x(f) and s(f) are the frequency spectra of the signals x(t) and s(t) respectively; and
h(f) is the frequency response of the composite channel of h(t)=h₁+h₂e^{jθ}e^{j2πfT}.

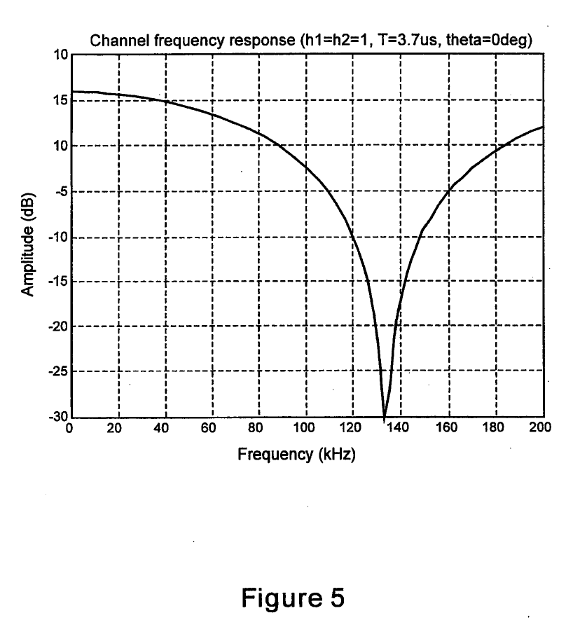

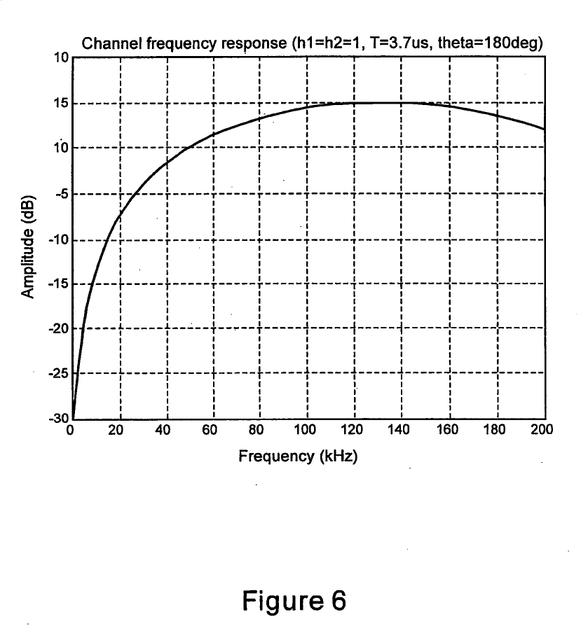

As an example, consider FIGS. 5 and 6, which respectively show the frequency response of h(f), with h₁=h₂=1 and T=3.7 μs where θ=0° (FIG. 5) and θ=180° (FIG. 6).

In the exemplary GSM embodiment, most of the energy of the baseband signal is concentrated in the low frequency region. Therefore, the channel response shown in FIG. 5 is preferable because it permits most of the signal energy to pass through, while the channel response in FIG. 6 shows most of the signal energy has been attenuated in the low frequency region.

Therefore, by varying the phase θ from frame to frame, the system 100 will never languish in the state described by FIG. 6 indefinitely. The analogy is to creating a fast fading channel.

A similar approach may be applied to the uplink channel. In this case, the delay can be introduced between two adjacent beams before combining them in the receiver. The equalizer in the base station will recover the signals from the different beams and coherently combine them in a manner well known in the art.

Simulations have shown that by implementing the inventive method of adding a delay period to alternating beams, one may achieve at least substantially similar performance as for on-line calibration, without the cost and complexity of the latter approach.

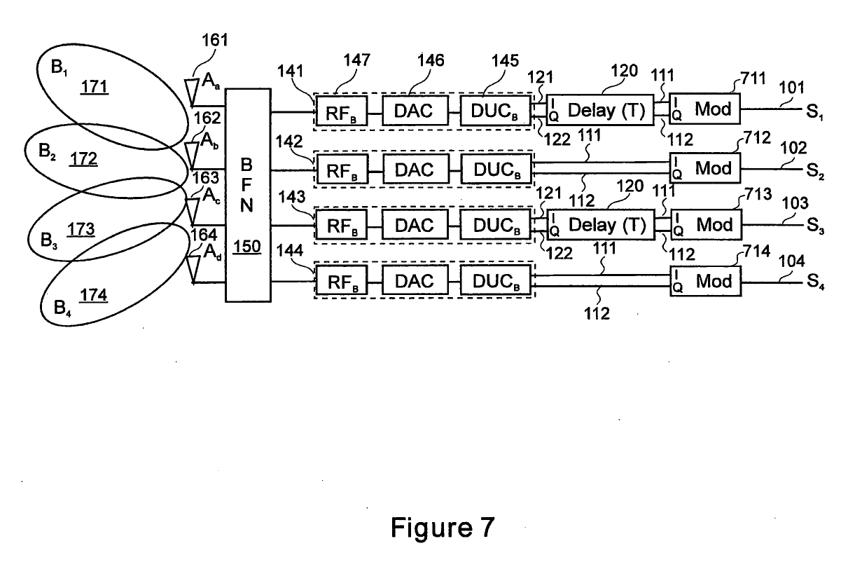

Rather than switching in and out of the system 100 as shown in FIG. 1, the conventional processing blocks 131-134 could be dispensed with and the individual input signal lines 101-104 could each be fed into a guadrature modulator 711-714, as shown in an alternative embodiment in FIG. 7. In such an embodiment, a broadcast signal could be simultaneously fed to each input signal line 101-104 in a manner well known to those having ordinary skill in this art. Thus, where beam synthesis is not required, the introduced delay on certain beams will not affect performance of the multi-beam antenna system.

By so doing, the need for costly real-time phase calibration is avoided and the cost of implementing beam synthesis is significantly reduced thereby.

Accordingly, the specification and the embodiments are to be considered exemplary only, with a true scope and spirit of the invention being disclosed by the following claims.

The embodiments of the present invention for which an exclusive property or privilege is claimed are:

1. A method for synthesizing a plurality of beams comprising at least one first beam having a coverage area overlapping with a coverage area of at least one second beam in a multi-beam antenna system comprising:
transmitting at least one first signal to be broadcast across a corresponding one of the at least one first beam;
transmitting at least one second signal after a delay across a corresponding one of the at least one second beam, so that a delay is applied to the at least one first signal relative to the at least one second beam;
whereby when the at least one first signal and the at least one second signal are identical, the likelihood of destructive interference between the at least one first beam and the at least one second beam is minimized.

2. A method according to claim 1, wherein the delay obviates any requirement for on-line phase calibration of the antenna system.

3. A method according to claim 1, wherein none of the at least one first beams have overlapping coverage areas and none of the at least one second beams have overlapping coverage areas.

4. A method according to claim 1, wherein the steps of transmitting each comprise:
breaking up the signal into in-phase and a quadrature components;
processing each component separately; and
combining the processed components before transmitting the signal.

5. A method according to claim 1, wherein the delay is a substantially equal to a symbol period.

6. A method according to claim 1, wherein the delay is substantially equal to a signal chirp period.

7. A method according to claim 1, wherein the delay is substantially equal to a multiple of a symbol period.

8. A method according to claim 1, wherein the delay is substantially equal to a fraction of a symbol period.

9. A method according to claim 1, wherein the delay is introduced in the downlink channel.

10. A method according to claim 1, wherein the delay is introduced in the uplink channel.

11. A method according to claim 8, wherein the delay is introduced before combining received signals.

12. A method according to claim 1, wherein the delay minimally impacts the reception of different signals along adjacent beams.

13. A method according to claim 1, wherein a receiver having an equalizer may receive and combine the at least one first beam and the at least one second beam to enhance the signal quality of the transmitted identical first and second signals respectively transmitted therealong.

14. An apparatus for synthesizing a plurality of beams in a multi-beam antenna system, comprising:
at least one first beam processor having a corresponding at least one first beam; and
at least one second beam processor having a corresponding at least one second beam, the coverage area of the at least one first beam overlapping the coverage area of the at least one second beam;
each of the at least one second beam processors comprising a delay element so that a delay may applied to at least one second signal to be broadcast along a corresponding one of the at least one second beam relative to at least one first signal to be broadcast along a corresponding one of the at least one first beam;
whereby, when the first and second signals are identical, the likelihood of destructive interference between the at least one first beam and the at least one second beam is minimized.

15. An apparatus according to claim 14, wherein the delay element accepts the at least one second signal before processing by the corresponding at least one second beam processor.

16. An apparatus according to claim 14, further comprising at least one quadrature modulator for dividing the at least one first signal and the at least one second signal into in-phase and quadrature components thereof.

17. An apparatus according to claim 16, wherein the quadrature modulator comprises a Gaussian filter.

18. An apparatus according to claim 16, wherein the quadrature modulator comprises an integrator.

19. An apparatus according to claim 16, wherein the quadrature modulator comprises a cosine function.

20. An apparatus according to claim 16, wherein the quadrature modulator comprises a sine function.

21. An apparatus according to claim 14, wherein the at least one first beam processor and the at least one second beam processor each comprise a digital up-converter.

22. An apparatus according to claim 21, wherein the digital up-converter comprises an up-sampler.

23. An apparatus according to claim 21, wherein the digital up-converter comprises a low pass filter.

24. An apparatus according to claim 21, wherein the digital up-converter comprises a cosine mixer.

25. An apparatus according to claim 21, wherein the digital up-converter comprises a sine mixer.

26. An apparatus according to claim 21, wherein the digital up-converter comprises a combining mixer.

27. An apparatus according to claim 14, wherein the at least one first beam processor and the at least one second beam processor each comprise a digital to analog converter.

28. An apparatus according to claim 14, wherein the at least one first beam processor and the at least one second beam processor each comprise an RF circuit.

29. An apparatus according to claim 28, wherein the RF circuit comprises a first bandpass filter.

30. An apparatus according to claim 28, wherein the RF circuit comprises a cosine mixer.

31. An apparatus according to claim 29, wherein the RF circuit comprises a second bandpass filter.

32. An apparatus according to claim 28, wherein the RF circuit comprises a power amplifier.

33. An apparatus according to claim 14, wherein the delay element comprises a digital signal processor.

34. An apparatus according to claim 13, wherein the delay element comprises a floating point gate array.
